(19) United States
(12) Patent Application Publication
(10) Pub. No.: US 2026/0326290 A1
(43) Pub. Date: Oct. 22, 2026

(54) METHOD AND APPARATUS FOR DETERMINING GRASPING POINT OF OBJECT IN MANIPULATOR SYSTEM

(71) Applicants: Hyundai Motor Company, Seoul (KR); Kia Corporation, Seoul (KR)

(72) Inventors: Sunwoo Lee, Hwaseong (KR); Sangyun Lee, Hwaseong (KR)

(21) Appl. No.: 19/422,355

(22) Filed: Dec. 16, 2025

(30) Foreign Application Priority Data
Apr. 18, 2025 (KR) 10-2025-0050899

(51) Int. Cl. B25J 9/16

(52) U.S. Cl. CPC B25J 9/1612; B25J 9/1697

(57) ABSTRACT

Systems and methods for determining a grasping point for an object in a manipulator system are provided. The method may comprise acquiring multiple IR image data and RGB image data regarding a target object using a stereo camera included in a manipulator, determining a disparity map based on the multiple IR image data regarding the target object, determining detection information for the target object based on the RGB image data, determining matching depth information for the target object based on the disparity map and the RGB image data, and determining a grasping point for the target object using the detection information and the matching depth information.

### CROSS-REFERENCE TO RELATED APPLICATION

This application claims, under 35 U.S.C. § 119 (a), the benefit of Korean Patent Application No. 10-2025-0050899, filed Apr. 18, 2025, in the Korean Intellectual Property Office, the entire contents of which are incorporated herein by reference.

### BACKGROUND

### (a) Technical Field

The disclosure relates to a method and apparatus for determining a grasping point for an object in a manipulator system.

### (b) Background

A manipulator is a mechanism, in a robot or automated system, configured to accurately pick up or hold an object and move it to a desired position. Manipulators are used in various systems and fields such as, e.g., industrial robots, medical robots, logistics and delivery robots, space and military robots, and service robots.

In order to accurately pick up or grasp an object using a manipulator, it is essential to accurately determine a distance from a camera to the object (i.e., a depth to the object). In this regard, a depth for an object may be detected using a disparity map representing a pixel-level position difference between two images captured by a stereo camera (or a multi-view camera).

However, when an object to be grasped is a transparent object, an object with a high surface reflectance, or an object positioned in a very close proximity, there is a problem in that depth detection performance for the object is significantly degraded. Accordingly, there is a need to develop a technology capable of accurately predicting a grasping point for an object by improving the performance of depth detection in a real environment where a manipulator is operated.

### SUMMARY

The present disclosure attempts to provide a method for determining an object grasping point capable of improving accuracy of the grasping point by utilizing a disparity map determined by a deep learning-based stereo matching model in a situation where accuracy of depth detection for the object is low.

Technical objects desired to be achieved in the present disclosure are not limited to the aforementioned objects, and other technical objects not described above will be apparent to those skilled in the art from the disclosure of the present disclosure.

An embodiment of the present disclosure provides a method for determining a grasping point for an object in a manipulator system, including acquiring multiple IR image data and RGB image data regarding a target object using a stereo camera included in a manipulator, determining a disparity map based on the multiple IR image data regarding the target object, determining detection information for the target object based on the RGB image data, determining matching depth information for the target object based on the disparity map and the RGB image data, and determining a grasping point for the target object using the detection information and the matching depth information.

The target object may include an object that includes a transparent or highly reflective surface.

The multiple IR image data may include first IR image data and second IR image data, and the determining of the disparity map may include inputting the first IR image data and the second IR image data into a stereo matching model to determine the disparity map.

The determining of the disparity map may include extracting a first feature map for the target object from the first IR image data; extracting a second feature map for the target object from the second IR image data, generating a cost volume based on a similarity calculation for the first feature map and the second feature map, and determining the disparity map based on pixel-wise matching of the first feature map and the second feature map performed using the cost volume.

The determining of the disparity map based on the pixel-wise matching of the first feature map and the second feature map may include optimizing pixel-wise matching at different resolutions based on a convolution calculation or a deconvolution calculation performed on the cost volume.

The stereo matching model may be learned to minimize the loss function for matching the first disparity map and the second disparity map, which are respectively output by receiving the first IR image data and the second IR image data as inputs.

The determining of the detection information may include determining a first center point of the target object by inputting the RGB image data into an object detection model.

The determining of the matching depth information may include determining depth image data for the target object based on the disparity map, converting the depth image data based on a coordinate system of the RGB image data, and aligning depth image data closest to the target object among the converted depth image data to the RGB image data.

The determining of the grasping point for the target object may include determining a second center point for the target object corresponding to the first center point based on the matching depth information, and determining the second center point as a grasping point for the target object based on verification of validity of the second center point.

The validity of the second center point may be verified by comparing an average value of a depth of a 3D point cloud included within a predetermined distance from the second center point with a preset threshold value.

Another embodiment of the present disclosure provides an apparatus for determining a grasping point for an object in a manipulator system, including a memory configured to store an object grasping point determination program; and a processor configured to execute the object grasping point determination program by loading the object grasping point determination program from the memory, and the processor may be configured to acquire multiple IR image data and RGB image data regarding a target object using a stereo camera included in a manipulator, to determine a disparity map based on the multiple IR image data regarding the target object, to determine detection information for the target object based on the RGB image data, to determine matching depth information for the target object based on the disparity map and the RGB image data, and to determine a grasping point for the target object using the detection information and the matching depth information.

The target object may include an object that includes a transparent or highly reflective surface.

The multiple IR image data may include first IR image data and second IR image data, and the processor may be configured to input the first IR image data and the second IR image data into a stereo matching model to determine the disparity map.

The processor may be configured to extract a first feature map for the target object from the first IR image data, to extract a second feature map for the target object from the second IR image, to generate a cost volume based on a similarity calculation for the first feature map and the second feature map, and to determine the disparity map based on pixel-wise matching of the first feature map and the second feature map performed using the cost volume.

The processor may be configured to optimize pixel-wise matching at different resolutions based on a convolution calculation or a deconvolution calculation performed on the cost volume.

The processor may be configured to determine a first center point of the target object by inputting the RGB image data into an object detection model.

The processor may be configured to determine depth image data for the target object based on the disparity map, to convert the depth image data based on a coordinate system of the RGB image data, and to align depth image data closest to the target object among the converted depth image data to the RGB image data.

The processor may be configured to determine a second center point for the target object corresponding to the first center point based on the matching depth information, and to determine the second center point as a grasping point for the target object based on verification of validity of the second center point.

The validity of the second center point may be verified by comparing an average value of a depth of a 3D point cloud included within a predetermined distance from the second center point with a preset threshold value.

Another embodiment provides a computer program stored on a non-transitory computer-readable recording medium, the computer program, when executed by a processor, has instructions for causing the processor to perform a mobility driving control method, including acquiring multiple IR image data and RGB image data regarding a target object using a stereo camera included in a manipulator, determining a disparity map based on the multiple IR image data regarding the target object, determining detection information for the target object based on the RGB image data, determining matching depth information for the target object based on the disparity map and the RGB image data, and determining a grasping point for the target object using the detection information and the matching depth information.

According to an embodiment, by estimating the center point of the target object using an object detection model and the stereo matching model and verifying validity of the estimated center point, it may be possible to improve accuracy of grasping point prediction.

According to an embodiment, by aligning the depth image data closest to the target object with the RGB image data and removing other noise, it may be possible to enhance detection performance for the target object.

In addition, according to an embodiment, by determining the optimized disparity map using the deep learning-based stereo matching model, it may be possible to minimize depth errors for objects with transparent or highly reflective surfaces.

According to an aspect of the present disclosure, a method for determining a grasping point for an object in a manipulator system is provided. The method may comprise acquiring infrared (IR) image data and RGB image data regarding a target object using a stereo camera. The stereo camera may be a component of a manipulator. The method may comprise, using a computing device, determining a disparity map based on the IR image data, determining detection information for the target object based on the RGB image data, determining matching depth information for the target object based on the disparity map and the RGB image data, and determining a grasping point for the target object using the detection information and the matching depth information.

According to an exemplary embodiment, the target object may comprise an object, and the object may comprise a transparent or highly reflective surface.

According to an exemplary embodiment, the IR image data may comprise first IR image data and second IR image data, and the determining the disparity map may comprise inputting the first IR image data and the second IR image data into a stereo matching model to determine the disparity map.

According to an exemplary embodiment, the determining the disparity map may comprise extracting a first feature map for the target object from the first IR image data, extracting a second feature map for the target object from the second IR image data, generating a cost volume based on a similarity calculation for the first feature map and the second feature map, and determining the disparity map based on pixel-wise matching of the first feature map and the second feature map performed using the cost volume.

According to an exemplary embodiment, the determining the disparity map based on the pixel-wise matching of the first feature map and the second feature map may comprise optimizing pixel-wise matching at different resolutions based on a convolution calculation or a deconvolution calculation performed on the cost volume.

According to an exemplary embodiment, the stereo matching model may be learned to minimize the loss function for matching the first disparity map and the second disparity map, which are respectively output by receiving the first IR image data and the second IR image data as inputs.

According to an exemplary embodiment, the determining the detection information may comprise determining a first center point of the target object by inputting the RGB image data into an object detection model.

According to an exemplary embodiment, the determining the matching depth information may comprise determining depth image data for the target object based on the disparity map, converting the depth image data based on a coordinate system of the RGB image data, and aligning depth image data closest to the target object among the converted depth image data to the RGB image data.

According to an exemplary embodiment, the determining of the grasping point for the target object may comprise determining a second center point for the target object corresponding to the first center point based on the matching depth information, and determining the second center point as a grasping point for the target object based on verification of validity of the second center point.

According to an exemplary embodiment, the method may comprise verifying the validity of the second center point. The verifying may comprise comparing an average value of a depth of a 3D point cloud included within a predetermined distance from the second center point with a preset threshold value.

According to an aspect of the present disclosure, an apparatus for determining a grasping point for an object in a manipulator system is provided. The apparatus may comprise a computing device comprising a processor an a memory. The memory may be configured to store instructions that, when executed by the processor, are configured to cause the processor to acquire infrared (IR) image data and RGB image data regarding a target object using a stereo camera included in a manipulator, determine a disparity map based on the IR image data, determine detection information for the target object based on the RGB image data, determine matching depth information for the target object based on the disparity map and the RGB image data, and determine a grasping point for the target object using the detection information and the matching depth information.

According to an exemplary embodiment, the target object may comprise an object. The object may comprise a transparent or highly reflective surface.

According to an exemplary embodiment, the IR image data may comprise first IR image data and second IR image data, and the computing device may be configured to input the first IR image data and the second IR image data into a stereo matching model to determine the disparity map.

According to an exemplary embodiment, the computing device may be configured to extract a first feature map for the target object from the first IR image data, extract a second feature map for the target object from the second IR image, generate a cost volume based on a similarity calculation for the first feature map and the second feature map, and determine the disparity map based on pixel-wise matching of the first feature map and the second feature map performed using the cost volume.

According to an exemplary embodiment, the computing device may be configured to optimize pixel-wise matching at different resolutions based on a convolution calculation or a deconvolution calculation performed on the cost volume.

According to an exemplary embodiment, the computing device may be configured to determine a first center point of the target object by inputting the RGB image data into an object detection model.

According to an exemplary embodiment, the computing device may be configured to determine depth image data for the target object based on the disparity map, convert the depth image data based on a coordinate system of the RGB image data, and align depth image data closest to the target object among the converted depth image data to the RGB image data.

According to an exemplary embodiment, the computing device may be configured to determine a second center point for the target object corresponding to the first center point based on the matching depth information, and determine the second center point as a grasping point for the target object based on verification of validity of the second center point.

According to an exemplary embodiment, the computing device may be configured to verify the validity of the second center point by comparing an average value of a depth of a 3D point cloud included within a predetermined distance from the second center point with a preset threshold value.

According to an aspect of the present disclosure, a computing device is provided. The computing device may comprise a non-transitory computer-readable recording medium configured to store instructions that, when executed by a processor, are configured to cause the processor to acquire infrared (IR) image data and RGB image data regarding a target object using a stereo camera included in a manipulator, determine a disparity map based on the IR image data, determine detection information for the target object based on the RGB image data, determine matching depth information for the target object based on the disparity map and the RGB image data, and determine a grasping point for the target object using the detection information and the matching depth information.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a block diagram showing an object grasping point determination apparatus, according to an exemplary embodiment of the present disclosure.

FIG. 2 illustrates a conceptual block diagram showing a function of an object grasping point determination program, according to an exemplary embodiment of the present disclosure.

FIG. 3 illustrates a flowchart showing a method for determining an object grasping point in a manipulator system, according to an exemplary embodiment of the present disclosure.

FIG. 4 illustrates an example of detection of a grasping point for a target object based on whether or not the target object is detected in a manipulator system, according to an exemplary embodiment of the present disclosure.

FIG. 5 illustrates an example of a training operation of a deep learning-based stereo matching model, which receives multiple IR image data as input and outputs an optimal disparity map, according to an exemplary embodiment of the present disclosure.

FIG. 6 illustrates an example showing a disparity map determined using a conventional stereo camera and a disparity map determined using a deep learning-based stereo matching model, according to an exemplary embodiment of the present disclosure.

FIG. 7 illustrates an example of determination of matching depth information based on image matching of RGB image data and depth image data, according to an exemplary embodiment of the present disclosure.

### DETAILED DESCRIPTION

The advantages and features of the present disclosure and the methods for accomplishing the same will be apparent from the embodiments described hereinafter with reference to the accompanying drawings. However, the present disclosure is not limited to the embodiments and may be embodied in various other forms or examples. These embodiments are provided so that this disclosure will be thorough and complete, and will fully convey the scope of the present disclosure to those skilled in the art. The scope of the present disclosure is defined in the appended claims.

In the following description of embodiments of the present disclosure, when a detailed description of known configurations or functions may obscure the subject matter of the present disclosure, a detailed description thereof will be omitted. Then, the terms described below are terms defined in consideration of functions in embodiments of the present disclosure, and may vary depending on the intention or custom of a user or operator. Accordingly, the definition should be based on the contents throughout this specification.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

It will be understood that, when a component is referred to as being “connected to” or “coupled to” another component, the component may be directly connected to or coupled to the other component, or intervening components may also be present. In contrast, when a component is referred to as being “directly connected to” or “directly brought into contact with” another component, there is no intervening component present. Other terms used to describe relationships between components such as “between” versus “directly between” and “adjacent” versus “directly adjacent” should be interpreted in a like fashion.

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the other part are indirectly electrically connected to each other.

In addition, the term “unit,” “control unit,” “control device,” or “controller” is merely a widely used term for naming an element or component that controls a specific function, and does not mean a generic functional unit. For example, each controller may include a communication device that communicates with another controller or a sensor to control a function assigned thereto, a computer-readable recording medium that stores an operating system (OS), logic commands, input/output information, and the like, and at least one processor that performs determination, calculation, computation, decision, and the like that are necessary for controlling a function assigned thereto.

Meanwhile, the processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, the computer-readable recording medium (or simply a “memory”) may include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, various embodiments of the present disclosure will be described in detail with reference to the accompanying drawings.

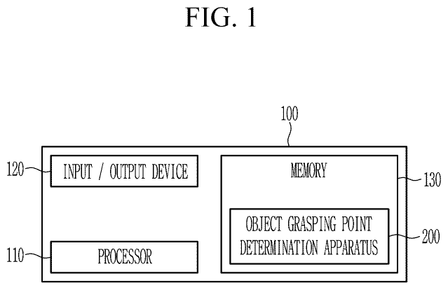

FIG. 1 illustrates a block diagram showing an object grasping point determination apparatus, according to an exemplary embodiment of the present disclosure.

Referring to FIG. 1, the object grasping point determination apparatus 100 may comprise a processor 110, an input/output device 120, and a memory 130. According to an exemplary embodiment, the object grasping point determination apparatus 100 may comprise, or be a component of, a computing device.

The controller 110 may be configured to generally control an operation of the object grasping point determination apparatus 100.

The processor 110 may be configured to receive a plurality of infrared (IR) image data and RGB image data regarding a target object using the input/output device 120.

Specifically, the processor 110 may be configured to receive image data (e.g., RGB image data, RGB video data, IR image data, IR video data, etc.) formed of at least one frame for a target object from at least one image acquired using at least one stereo camera included in a manipulator. In this specification, for better understanding and ease of description, it has been described that at least one image data including the target object, or image data formed of one or more frames of the target object, may be input through the input/output device 120, but the present disclosure is not limited thereto. That is, according to an exemplary embodiment, the object grasping point determination apparatus 100 may comprise a transceiver (not shown), and the object grasping point determination apparatus 100 may be configured to receive at least one of image data including the target object or image data formed of at least one frame for the target object using the transceiver (not shown), and at least one of the image data including the target object or the image data formed of at least one frame for the target object may be collected or generated within the object grasping point determination apparatus 100.

The processor 110 may be configured to determine a disparity map from multiple IR image data acquired by the stereo camera, determine matching depth information of the target object based on the disparity map and RGB image data, determine detection information of the target object from the RGB image data, and determine a grasping point for the target object by utilizing the detection information and the matching depth information.

The input/output device 120 may comprise one or more input devices and/or one or more output devices. For example, the input devices may comprise a microphone, a keyboard, a mouse, a touch screen, etc., and the output devices may comprise a display, speaker, etc.

The memory 130 may be configured to store instructions such as an object grasping point determination program 200 and information necessary for executing the object grasping point determination program 200.

In this specification, the object grasping point determination program 200 may refer to a software that comprise instructions for determining the grasping point of the target object by utilizing detection information and matching depth information, which are determined based on multiple IR image data and RGB data acquired by the stereo camera.

The processor 110 may be configured to load the object grasping point determination program 200 and information necessary for executing the object grasping point determination program 200 from the memory 130 to execute the object grasping point determination program 200.

The processor 110 may be configured to acquire multiple IR image data and RGB image data related to the target object using the stereo camera included in the manipulator, determine the disparity map from the multiple IR image data, determine detection information of the target object based on the RGB image data, determine matching depth information of the target object based on the disparity map and the RGB image data, and determine a grasping point for the target object by utilizing the detection information and the matching depth information.

In the present disclosure, the manipulator system may comprise a system configured for performing environmental recognition and feedback control of the manipulator, capable of performing object tracking control or object grasping control for the manipulator based on information processed using a camera and image processing.

In the present disclosure, the target object may be an object that comprises a transparent or highly reflective surface, and may comprise, e.g., an object formed of a glass, plastic, or metal surface, etc.

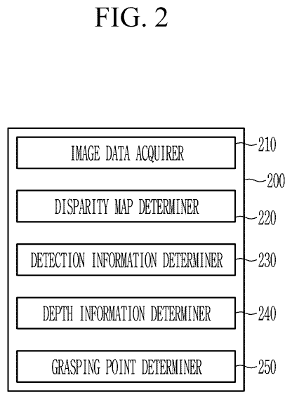

Functions and/or operations of the object grasping point program 200 will be described in detail with reference to FIG. 2.

FIG. 2 illustrates a conceptual block diagram showing a function of an object grasping point determination program, according to an exemplary embodiment.

Referring to FIG. 2, the object grasping point determination program 200 may comprise an image data acquirer 210, a disparity map determiner 220, a detection information determiner 230, a depth information determiner 240, and a grasping point determiner 250.

The image data acquirer 210, the disparity map determiner 220, the detection information determiner 230, the depth information determiner 240, and the grasping point determiner 250 illustrated in FIG. 2 may be elements which are conceptually divided according to the functions of the object grasping point determination program 200 to easily describe the functions of the object grasping point determination program 200, but the present disclosure is not limited thereto. According to embodiments, the functions of the image data acquirer 210, the disparity map determiner 220, the detection information determiner 230, the depth information determiner 240, and the grasping point determiner 250 may be merged or separated, and may be implemented as a series of instructions included in a single program.

First, the image data acquirer 210 may be configured to acquire multiple IR image data and RGB image data regarding the target object using a stereo camera included in the manipulator. Herein, the target object may comprise an object that comprises a transparent or highly reflective surface. Additionally, the target object may comprise an object positioned very close to the camera (e.g., within a distance of 20 cm).

Additionally, the stereo camera may comprise a left camera module and a right camera module positioned at a predetermined reference distance (i.e., baseline). Each of a left camera module and a right camera module, according to an exemplary embodiment, may comprise an RGB sensor and an IR sensor.

For example, the image data acquirer 210 may be configured to acquire first IR image data using the left camera module, and may be configured to acquire second IR image data using the right camera module.

For another example, the image data acquirer 210 may be configured to acquire RGB image data using at least one of the left camera module or the right camera module.

Next, the disparity map determiner 220 may be configured to determine a disparity map based on the plurality of IR image data regarding the target object.

Herein, the plurality of IR image data may comprise first IR image data and second IR image data.

In addition, the disparity map may refer to a data map created by calculating a positional difference between corresponding points in left and right images capturing a same scene, and based on the disparity map, depth image data including a depth value for each pixel may be determined.

Specifically, the disparity map determiner 220 may be configured to determine the disparity map by inputting the first IR image data and the second IR image data into a stereo matching model.

In addition, the stereo matching model, according to an exemplary embodiment, may refer to a deep learning-based neural network model that receives a stereo image pair acquired from the left camera module and the right camera module as input and predicts a pixel-wise disparity map.

Specifically, the disparity map determiner 220 may be configured to extract a first feature map for a target object from the first IR image data.

Additionally, the disparity map determiner 220 may be configured to extract a second feature map for the target object from the second IR image data.

Herein, the first feature map and the second feature map may each refer to a mapping of features extracted by inputting IR image data acquired using the left camera module and the right camera module into a two-dimensional convolutional neural network (2D CNN).

Meanwhile, the disparity map determiner 220 may be configured to generate a cost volume based on a similarity calculation for the first feature map and the second feature map.

Herein, the cost volume may refer to a four-dimensional tensor volume that stores matching similarity of each pixel pair included in the first feature map and the second feature map, and may indicate how well the extracted features match.

For example, the disparity map determiner 220 may be configured to generate the cost volume using a sum of squared differences (SSD) similarity metric or normalized cross-correlation (NCC) similarity metric.

Additionally, the disparity map determiner 220 may be configured to determine the disparity map based on pixel-wise matching between the first feature map and the second feature map, which is performed using the cost volume.

Specifically, the disparity map determiner 220 may be configured to optimize pixel-wise matching at different resolutions based on a convolution calculation or a deconvolution calculation performed on the cost volume.

Additionally, the disparity map determiner 220 may be configured to determine an optimized disparity map based on the pixel-wise matching optimized at different resolutions.

For example, the disparity map determiner 220 may be configured to determine the optimized disparity map using a ML-argmax function.

The optimized disparity may vary depending on a loss function or optimization method used in training the stereo matching model.

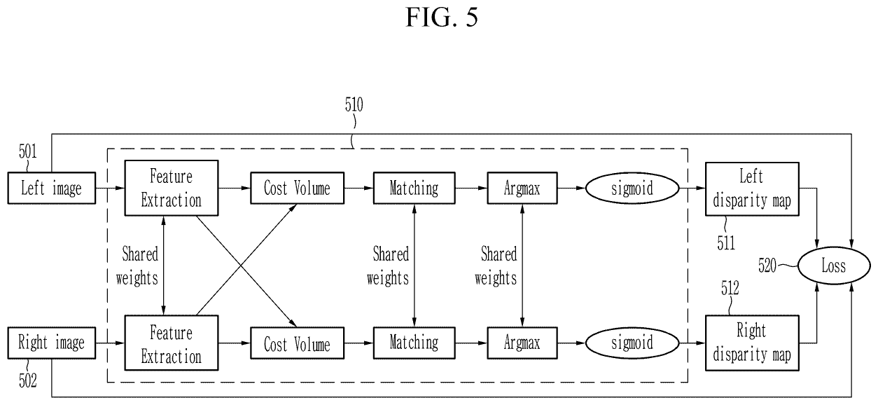

In the present disclosure, a stereo matching model may be learned to minimize the loss function for matching the first disparity map and the second disparity map, which are respectively output by receiving the first IR image data and the second IR image data as inputs, as described in detail later in FIG. 5.

As such, in the present disclosure, by determining the optimized disparity map using the deep learning-based stereo matching model, an unique effect of minimizing depth errors for objects with transparent or highly reflective surfaces may be achieved.

Next, the detection information determiner 230 may be configured to determine detection information for the target object based on RGB image data.

Specifically, the detection information determiner 230 may be configured to determine detection information for the target object using an object detection model (e.g., CenterNet, FCOS, YOLO model, etc.). Herein, the detection information for the target object may refer to information about a feature point or a center point of the target object.

For example, the detection information determiner 230 may be configured to determine a first center point of the target object estimated by inputting RGB image data of the target object into a YOLO model.

Herein, the first center point may refer to 2D center coordinates of the target object.

Meanwhile, if a target object is not detected from the RGB image data, the detection information determiner 230 may be configured to transmit a manipulator position adjustment request signal to the manipulator system. Herein, the manipulator system may be configured to control adjustment of a position of the manipulator based on the position adjustment request signal.

Additionally, the detection information determiner 230 may be configured to determine detection information for the target object from RGB image data acquired based on adjustment of the position of the manipulator.

Meanwhile, a type of object detection model, according to an exemplary embodiment, is merely an example, and may be variously modified within a scope of achieving the purpose of the present disclosure.

Next, the depth information determiner 240 may be configured to determine matching depth information for the target object based on the disparity map and RGB image data.

Herein, the matching depth information, according to an exemplary embodiment, may refer to data regarding a depth image in which a RGB image and a depth image are precisely aligned on a pixel-by-pixel basis, thereby assigning a depth value corresponding to each RGB pixel.

Specifically, the depth information determiner 240 may be configured to determine depth image data for the target object from the disparity map.

For example, the depth information determiner 240 may be configured to determine depth image data for the target object based on the disparity map determined from a plurality of IR image data acquired through a stereo camera.

Herein, the relationship between disparity and depth, according to an exemplary embodiment, may be expressed as following Equation 1.

$$Z = \frac{f \cdot B}{d} \qquad Equation 1$$

Herein, Z may refer to depth, f may refer to a focal distance of the camera, B may refer to a baseline between two camera modules, and d may refer to disparity.

Additionally, the depth information determiner 240 may be configured to convert the depth image data based on a coordinate system of the RGB image data.

More specifically, the depth information determiner 240 may be configured to align the depth image data with the RGB image data using a camera matrix that includes parameters (e.g., intrinsic parameter and extrinsic parameter) of a camera acquiring RGB image data and a camera acquiring depth image data.

Additionally, the depth information determiner 240 may be configured to align depth image data closest to the target object among the converted depth image data to the RGB image data.

In this regard, according to coordinate system transformation of the depth image data, multiple depth values may be mapped to a same position coordinates in the RGB coordinate system, and among the multiple depth values, a depth value of the object closest to the camera may correspond to the depth value for the target object.

In this way, in the present disclosure, by aligning the depth image data closest to the target object with the RGB image data and removing other noise, the unique effect of enhancing detection performance for the target object may be achieved.

Next, the grasping point determiner 250 may be configured to determine a grasping point for the target object using the detection information and the aligned depth information. Herein, the grasping point, according to an exemplary embodiment, may refer to a center point of the target object.

Specifically, the grasping point determiner 250 may be configured to determine a second center point for the target object corresponding to the first center point based on the matching depth information. Herein, the second center point may refer to 3D coordinates of the target object. In this way, in the present disclosure, the center point of the target object may be estimated primarily using the object detection model, and the center point of the target object may be estimated secondarily using the stereo matching model.

Additionally, the grasping point determiner 250 may be configured to determine the second center point as the grasping point for the target object based on verification of validity of the second center point.

Herein, the validity verification, according to an exemplary embodiment, may refer to verifying how closely the center point estimated through the object detection model and the stereo matching model matches an actual center point of the target object.

Specifically, the grasping point determiner 250 may be configured to verify validity of the second center point by comparing an average value of a depth of a 3D point cloud included within a predetermined distance from the second center point with a preset threshold value.

Accordingly, by referring to depth variations in surrounding points, a unique effect of verifying whether the depth value of the second center point remains consistently reliable may be achieved.

In this way, in the present disclosure, by estimating the center point of the target object using an object detection model and the stereo matching model and verifying validity of the estimated center point, a unique effect of improving accuracy of grasping point prediction may be achieved.

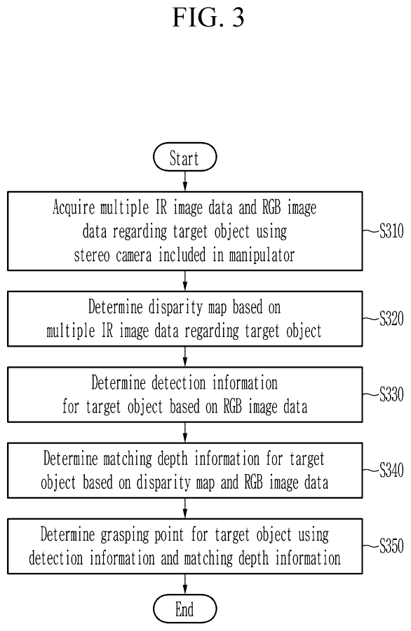

FIG. 3 illustrates a flowchart showing a method for determining an object grasping point in a manipulator system, according to an exemplary embodiment.

Referring to FIG. 3, the image data acquirer 210 may be configured to acquire multiple IR image data and RGB image data regarding the target object using a stereo camera included in the manipulator (S310).

Next, the disparity map determiner 220 may be configured to determine a disparity map based on the plurality of IR image data regarding the target object (S320).

In addition, the detection information determiner 230 may be configured to determine detection information for the target object based on RGB image data (S330).

Next, the depth information determiner 240 may be configured to determine matching depth information for the target object based on the disparity map and RGB image data (S340).

Next, the grasping point determiner 250 may be configured to determine a grasping point for the target object using detection information and matching depth information (S350).

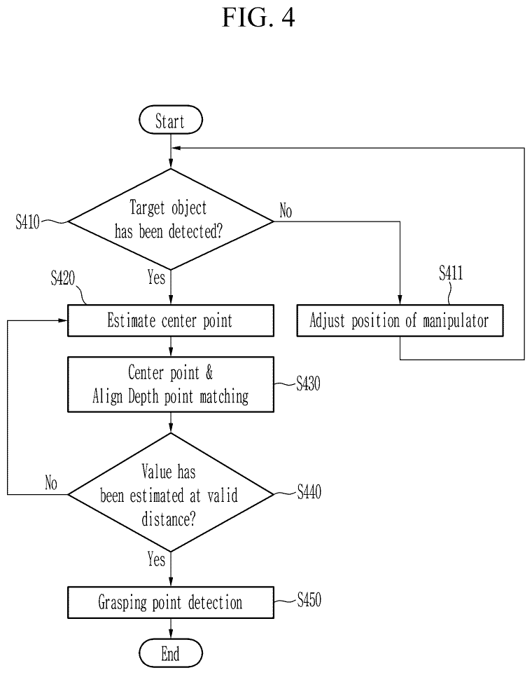

FIG. 4 illustrates an example of detection of a grasping point for a target object based on whether or not the target object is detected in a manipulator system, according to an exemplary embodiment.

Referring to FIG. 4, the object grasping point determination apparatus 100 may be configured to determine whether a target object has been detected based on segmentation of RGB image data acquired through a stereo camera included in the manipulator (S410).

If the target object is not detected, the manipulator system may be configured to adjust a position of the manipulator (S411). Herein, the target object may be re-detected through segmentation of RGB image data acquired at an adjusted position of the manipulator.

Meanwhile, if the target object is detected, the object grasping point determination apparatus 100 may be configured to input RGB image data into an object detection model to determine detection information including the first center point for the object (S420).

Next, the object grasping point determination apparatus 100 may be configured to determine a second center point corresponding to the first center point from the disparity map determined from a plurality of IR image data and matching depth information determined based on the RGB image data (S430).

Next, the object grasping point determination apparatus 100 may be configured to determine whether a value has been estimated at a valid distance based on the verification of the validity of the second center point (S440).

Herein, if the validity of the second center point is not verified, the object grasping point determination apparatus 100 may be configured to re-determine the first center point based on segmentation of the RGB image data.

In addition, if the validity of the second center point is verified, the object grasping point determination apparatus 100 may be configured to determine the grasping point for the target object using the estimated second center point (S450).

FIG. 5 illustrates an example of a training operation of a deep learning-based stereo matching model, which may be configured to receive multiple IR image data as input and output an optimal disparity map, according to an exemplary embodiment.

Referring to FIG. 5, a first IR image 501 acquired through a left camera module and a second IR image 502 acquired through a right camera module may each be input into a deep learning-based stereo matching model 510 to extract a first feature map and a second feature map.

Additionally, in the deep learning-based stereo matching model 510, a cost volume may be determined based on a similarity calculation for the first feature map and the second feature map.

In addition, in the deep learning-based stereo matching model 510, pixel-wise matching of the first feature map and the second feature map may be performed using the cost volume, and a first disparity map 511 and a second disparity map 512 may be estimated using a ML-argmax function and a sigmoid function.

Meanwhile, parameters of the deep learning-based stereo matching model 510 may be updated through backpropagation in a direction of minimizing a loss function 520. Herein, the loss function 520, according to an exemplary embodiment, may comprise a first loss to a third loss.

The first loss may refer to a loss (left-right consistency loss) that ensures the consistency of the first disparity map 511 and the second disparity map 512 is maintained.

The second loss may refer to a reconstruction loss, which represents a difference between an IR image reconstructed from the first disparity map 511 and the second IR image 502, as well as a difference between an IR image reconstructed from the second disparity map 512 and the first IR image 501.

The third loss may refer to a gradient-based smoothness loss to prevent an abrupt change in the disparity map.

In other words, the deep learning-based stereo matching model 510 may be trained based on the loss function 520 that includes the first to third losses, and by using the deep learning-based stereo matching model 510 trained based on the loss function 520, an optimized disparity map may be determined.

Meanwhile, the first to third losses constituting the loss function 520 are merely examples, and may be variously modified within a scope of achieving the purpose of the present disclosure.

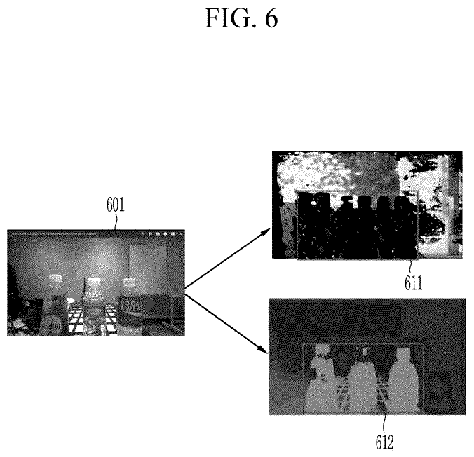

FIG. 6 illustrates an example showing a disparity map determined using a conventional stereo camera and a disparity map determined using a deep learning-based stereo matching model, according to an embodiment.

FIG. 6 illustrates an IR image 601 including a transparent object photographed at a close range (20 cm), and a first disparity map 611 and a second disparity map 612 determined from the IR image 601.

Herein, the first disparity map 611 is a disparity map determined using a stereo camera according to a conventional method (e.g., epipolar geometry), and the second disparity map 612 is a disparity map determined using a deep learning-based stereo matching model.

Referring to FIG. 6, a portion represented by black pixels in the first disparity map 611 is a region where disparity is not calculated, and proper depth detection from the first parallax map 611 is impossible.

Meanwhile, in the second disparity map 612, it may be seen that the disparity for multiple transparent plastic bottles included in the IR image 601 has been appropriately calculated.

Through this, it may be confirmed that, for transparent objects captured at a close range, depth detection performance is higher when using a deep learning-based stereo matching model compared to a conventional method that relies solely on a stereo camera.

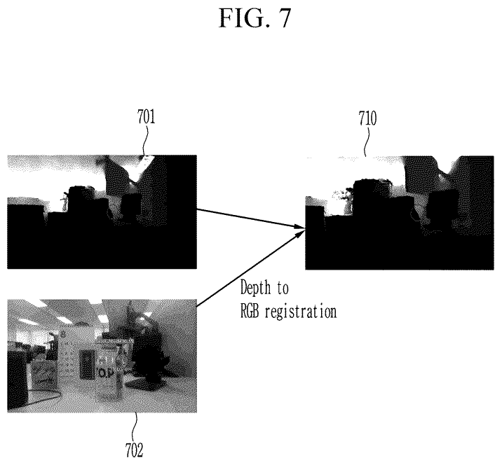

FIG. 7 illustrates an example of determination of matching depth information based on image matching of RGB image data and depth image data, according to an exemplary embodiment.

Referring to FIG. 7, the depth information determiner 240 may be configured to accurately align the RGB image and the depth image on a pixel-by-pixel basis based on image matching for depth image data 701 and RGB image data 702 for a coffee can, to determine matching depth information 710 for a depth image to which a depth value corresponding to each RGB pixel is assigned.

Herein, depth information determiner 240 may be configured to convert the depth image data 701 based on a coordinate system of the RGB image data 702, and may be configured to align a closest depth value corresponding to the coffee can among the converted depth image data to the RGB image data.

Combinations of each block in the block diagrams and each operation in the flowcharts attached to the present disclosure may also be executed by computer program instructions. These computer program instructions may be embedded in an encoding processor of a general-purpose computer, a special-purpose computer, or other programmable data processing apparatus, and thus the instructions, when executed by the encoding processor of the computer or other programmable data processing apparatus, may create a means for performing the functions described in each block of the block diagram or each operation of the flowchart. These computer program instructions may also be stored in a computer-available or computer-readable memory capable of directing a computer or other programmable data processing apparatus to implement functions in a particular manner, so the instructions stored in the computer-available or computer-readable memory may also produce an article of manufacture that includes instruction means for performing the functions described in each block of the block diagram or each operation of the flowchart. The computer program instructions may also be installed on a computer or other programmable data processing apparatus, a series of operations may be performed on the computer or other programmable data processing apparatus to create a computer-executable process, and the instructions that cause the computer or other programmable data processing apparatus to perform the operations for executing the functions described in each block of the block diagram and each operation of the flowchart may also provide operations for executing the functions described in each block of the block diagram and each operation of the flowchart.

Additionally, each block or each operation may represent a module, segment or portion of code that contains one or more executable instructions for executing a particular logical function(s). It should also be noted that in some alternative embodiments, the functions mentioned in the blocks or operations may occur out of order. For example, two blocks or operations shown in succession may in fact be performed substantially simultaneously, or the blocks or operations may sometimes be performed in reverse order, depending on the functionality they serve.

The above description is merely illustrative of the technical idea of the present disclosure, and those skilled in the art to which the present disclosure pertains may make various modifications and variations without departing from the essential characteristics of the present disclosure. Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A method for determining a grasping point for an object in a manipulator system, the method comprising:
acquiring image data and RGB image data regarding a target object using a camera, wherein the camera is a component of a manipulator; and
using a computing device:
determining a disparity map based on the image data;
determining detection information for the target object based on the RGB image data;
determining matching depth information for the target object based on the disparity map and the RGB image data; and
determining a grasping point for the target object using the detection information and the matching depth information.

2. The object grasping point determining method of claim 1, wherein;
the image data comprises infrared (IR) image data, and
camera comprises a stereo camera.

3. The object grasping point determining method of claim 2, wherein:
the target object comprises an object, and
the object comprises a transparent or highly reflective surface.

4. The object grasping point determining method of claim 2, wherein:
the IR image data comprises first IR image data and second IR image data, and
the determining the disparity map comprises inputting the first IR image data and the second IR image data into a stereo matching model to determine the disparity map.

5. The object grasping point determining method of claim 4, wherein:
the determining the disparity map comprises:
extracting a first feature map for the target object from the first IR image data;
extracting a second feature map for the target object from the second IR image data;
generating a cost volume based on a similarity calculation for the first feature map and the second feature map; and
determining the disparity map based on pixel-wise matching of the first feature map and the second feature map performed using the cost volume.

6. The object grasping point determining method of claim 5, wherein the determining the disparity map based on the pixel-wise matching of the first feature map and the second feature map comprises optimizing pixel-wise matching at different resolutions based on a convolution calculation or a deconvolution calculation performed on the cost volume.

7. The object grasping point determining method of claim 4, wherein the stereo matching model is learned to minimize the loss function for matching the first disparity map and the second disparity map, which are respectively output by receiving the first IR image data and the second IR image data as inputs.

8. The object grasping point determining method of claim 2, wherein:
the determining the detection information comprises determining a first center point of the target object by inputting the RGB image data into an object detection model, and
the determining the matching depth information comprises:
determining depth image data for the target object based on the disparity map;
converting the depth image data based on a coordinate system of the RGB image data; and
aligning depth image data closest to the target object among the converted depth image data to the RGB image data.

9. The object grasping point determining method of claim 8, wherein the determining the grasping point for the target object comprises:
determining a second center point for the target object corresponding to the first center point based on the matching depth information; and
determining the second center point as a grasping point for the target object based on verification of validity of the second center point, and
further comprising verifying the validity of the second center point,
wherein the verifying comprises comparing an average value of a depth of a 3D point cloud included within a predetermined distance from the second center point with a preset threshold value.

10. An apparatus for determining a grasping point for an object in a manipulator system, the apparatus comprising:
a computing device comprising a processor an a memory, wherein the memory is configured to store instructions that, when executed by the processor, are configured to cause the processor to:
acquire image data and RGB image data regarding a target object using a camera,
wherein the camera is a component of a manipulator;
determine a disparity map based on the image data;
determine detection information for the target object based on the RGB image data;
determine matching depth information for the target object based on the disparity map and the RGB image data; and
determine a grasping point for the target object using the detection information and the matching depth information.

11. The object grasping point determining apparatus of claim 10, wherein;
the image data comprises infrared (IR) image data, and
camera comprises a stereo camera.

12. The object grasping point determining apparatus of claim 11, wherein:
the target object comprises an object, and
the object comprises a transparent or highly reflective surface.

13. The object grasping point determining apparatus of claim 11, wherein:
the IR image data comprises first IR image data and second IR image data, and
the computing device is configured to input the first IR image data and the second IR image data into a stereo matching model to determine the disparity map.

14. The object grasping point determining apparatus of claim 13, wherein the computing device is configured to:
extract a first feature map for the target object from the first IR image data;
extract a second feature map for the target object from the second IR image;
generate a cost volume based on a similarity calculation for the first feature map and the second feature map;
determine the disparity map based on pixel-wise matching of the first feature map and the second feature map performed using the cost volume; and
optimize pixel-wise matching at different resolutions based on a convolution calculation or a deconvolution calculation performed on the cost volume.

15. The object grasping point determining apparatus of claim 11, wherein the computing device is configured to determine a first center point of the target object by inputting the RGB image data into an object detection model.

16. The object grasping point determining apparatus of claim 15, wherein the computing device is configured to:
determine depth image data for the target object based on the disparity map;
convert the depth image data based on a coordinate system of the RGB image data; and
align depth image data closest to the target object among the converted depth image data to the RGB image data.

17. The object grasping point determining apparatus of claim 16, wherein the computing device is configured to:
determine a second center point for the target object corresponding to the first center point based on the matching depth information; and
determine the second center point as a grasping point for the target object based on verification of validity of the second center point.

18. The object grasping point determining apparatus of claim 17, wherein the computing device is configured to verify the validity of the second center point by comparing an average value of a depth of a 3D point cloud included within a predetermined distance from the second center point with a preset threshold value.

19. A computing device, comprising:
a non-transitory computer-readable recording medium configured to store instructions that, when executed by a processor, are configured to cause the processor to:
acquire image data and RGB image data regarding a target object using a camera,
wherein the camera is a component of a manipulator;
determine a disparity map based on the image data;
determine detection information for the target object based on the RGB image data;
determine matching depth information for the target object based on the disparity map and the RGB image data; and
determine a grasping point for the target object using the detection information and the matching depth information.

20. The computing device of claim 19, wherein;
the image data comprises infrared (IR) image data, and
camera comprises a stereo camera.
